(19) United States
(12) Patent Application Publication
(10) Pub. No.: US 2008/0076491 A1
(43) Pub. Date: Mar. 27, 2008

(54) Portable terminal device

(75) Inventor: Yoshihiro Sugimoto, Kawasaki-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/633,343

(22) Filed: Dec. 1, 2006

(30) Foreign Application Priority Data
Sep. 8, 2006 (JP) 2006-244739

(51) Int. Cl. H04M 1/00

(52) U.S. Cl. 455/575.3

(57) ABSTRACT

A portable terminal device, capable of receiving distribution data from a server, comprises a detection unit to detect an operation state of the portable terminal device, and a control unit configured to calculates operation state points to determine whether or not the portable terminal device is in the operation state on the basis of the state detection result from the detection unit to determine whether or not the portable terminal device is in the operation state on the basis of the fact whether or not the operation state points exceed a prescribed threshold.

### CROSS-REFERENCE TO RELATED APPLICATIONS

This application is based upon and claims the benefit of priority from prior Japanese Patent Application No. 2006-244739, filed Sep. 8, 2006, the entire contents of which are incorporated herein by reference.

### BACKGROUND OF THE INVENTION

1. Field of the Invention

The present invention relates to a portable terminal device such as a portable telephone set.

2. Description of the Related Art

In recent years, an information distribution service for a portable terminal device such as a portable telephone set has been widely used. Here, as for a technique related to a portable terminal device capable of utilizing the information distribution service is disclosed, for instance, in Jpn. Pat. Appln. KOKAI Publication No. 2003-134198.

That is to say, according to a folding-type portable communication terminal disclosed in Jpn. Pat. Appln. KOKAI Publication No. 2003-134198, if a received message transmitted thorough a baseband processing unit is distribution information distributed in a push-type distribution (distribution system by which data distribution device transmits data without waiting for a transmission request for data from a data receiving device), a central processing unit (CPU) equipped with the folding-type portable communication terminal displays the distribution information in a prescribed display manner onto a display screen of a sub-LCD, LCD which can be observed by a user even in a condition where the folding-type portable communication terminal is folded, so that the user can observe the distribution information even with the folding-type portable communication terminal is folded.

Meanwhile, data distribution systems which have been used in the information distribution service, etc., are roughly classified as follows. That is, the distribution systems are roughly classified into “unicast distribution” in one and one correspondence between the data distribution device and the data receiving device, and “multicast distribution” in one and multi correspondence between one data distribution device and a plurality of data receiving devices.

At the present time, as for the information distribution service for the portable telephone set, the information distribution service by the unicast distribution has been provided. In future, it is a matter of time that the information distribution service for the portable telephone set by the multicast distribution will be put into practice.

Here, up to now, in the information distribution service for the portable telephone set, a failure rate of receiving the distribution information at each portable telephone set has become a problem. The failure rate thereof mainly occurs from the following causes.

That is to say, in a conventional portable telephone set, when the portable telephone set is not in a state of, so-called stand-by screen display, for example, when a mailer or a browser is in its active state, a control unit equipped for the portable telephone set determines that the corresponding portable telephone set is in an operation state. When being determined the operation state, the concerned portable telephone set cannot activate reception processing of the data, which is processing to download the data by accessing to a download server, transmitted in the information distribution service. Since the reception processing is performed on the basis of a time table obtained by the portable telephone in advance, if the reception processing results in a failure once, the reception processing of the data in the relevant time is not performed again.

Accordingly, up to now, even in a portable telephone not in an actual operation state, if it is left in a state in which the mailer or the browser has been activated due to the operation miss by the user, the concerned portable telephone set does not implement the reception processing in the information distribution service. In regard to a technique to resolve the problem, the Jpn. Pat. Appln. KOKAI Publication No. 2003-134198 does not suggest anything, to say nothing about its disclosure.

### BRIEF SUMMARY OF THE INVENTION

The present invention is invented by considering circumstances given above; an object of the present invention is to provide a portable terminal device having a high reception end rate of distribution data in utilizing information distribution service, etc.

To achieve the object, a portable terminal device regarding a first embodiment of the present invention is one capable of receiving distribution data from a server, and comprises a detection unit configured to detect an operation state of the portable terminal device; a determining unit configured to determine between a first state and a second state, the first state being that the portable terminal device is in the operation state on the basis of the state detection result by the detection unit; and a reception control unit configured to perform reception processing of the distribution data from the data distribution server if the determining unit determines that the portable terminal device is in the second state.

To establish the object, a portable terminal device regarding a second embodiment of the present invention is one capable of receiving distribution data from a data distribution server, and comprises a state detection unit which detects an operation state of the portable terminal device; a point calculation unit which calculates operation state points to determine whether or not the portable terminal device is in the operation state on the basis of the state detection result by the state detection unit; and a reception control unit which determines whether or not the operation state point has exceeded a prescribed threshold, and performs reception processing of the distribution data from the data distribution server if it is determined that the operation state points have not exceeded the prescribed threshold.

To achieve the object, a portable terminal device regarding a third embodiment of the present invention is one capable of receiving distribution data from a data distribution server, and comprises a state detection unit which detects an operation state of the portable terminal device; and a reception control unit which determines whether or not the portable terminal device is in the operation state, and performs reception processing of the distribution data from the data distribution server if it is determined that the portable terminal device is not in the operation state.

According to the present invention, a portable terminal device having a high reception end rate of the distribution data in utilizing the information distribution service can be provided.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary block diagram depicting a configuration of a portable telephone set regarding one embodiment of the present invention;

FIG. 2A is an exemplary front view when the portable telephone set regarding the one embodiment of the present invention is opened by around 180°;

FIG. 2B is an exemplary side view when the portable telephone set regarding the one embodiment of the present invention is opened by around 180°;

FIG. 3A is an exemplary front view when the portable telephone set regarding the one embodiment of the present invention is closed;

FIG. 3B is an exemplary side view when the portable telephone set regarding the one embodiment of the present invention is closed;

FIG. 4A is an exemplary view depicting a display example of a display unit;

FIG. 4B is an exemplary view depicting one example of a key arrangement;

FIG. 5 is an exemplary view depicting a flowchart of reception processing processes of distribution data in an information distribution service (unicast distribution) by a control unit of the portable telephone set of the one embodiment of the present invention;

FIG. 6 is an exemplary view depicting one example of a calculation table of operation state points; and

FIG. 7 is an exemplary view depicting a flowchart of reception processing processes of distribution data in an information distribution service (multicast distribution) by the control unit of the portable telephone set of the one embodiment of the present invention.

### DETAILED DESCRIPTION OF THE INVENTION

Hereinafter, a portable telephone set regarding one embodiment of the present invention will be set forth with reference to the drawings.

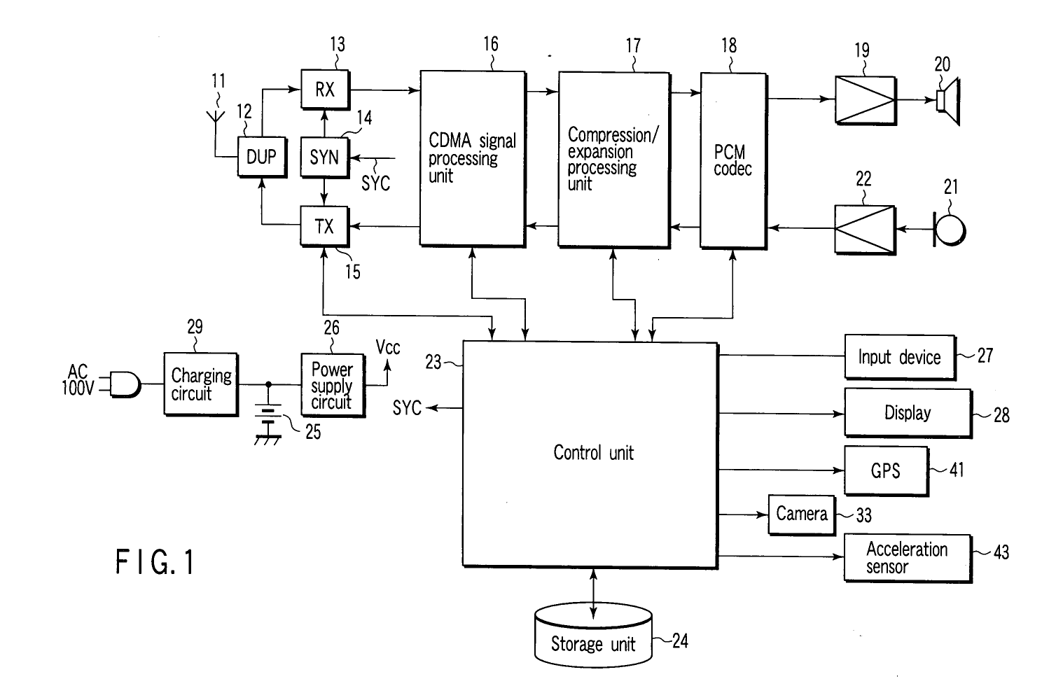

FIG. 1 is a block diagram illustrating a configuration of the portable telephone set regarding the one embodiment of the present invention.

In FIG. 1, a radio signal transmitted from a base station, not shown, is received by an antenna 11 then input to a receiving circuit (RX) 13 through an antenna duplexer (DUP) 12. The RX 13 mixes the received radio signal with a local oscillation signal output from a frequency synthesizer (SYN) 14 to frequency-convert (down-convert) into an intermediate frequency signal. The RX 13 then conducts quadrature demodulation of the down-converted intermediate frequency signal to output a received baseband signal. The frequency of the local oscillation signal generated from the SYN 14 is instructed by a control signal SYC output from a control unit 23.

The received baseband signal is input to a code division multiple access (CDMA) signal processing unit 16. The CDMA signal processing unit 16 has a RAKE receiver. The RAKE receiver performs reverse diffusion processing to a plurality of paths included in the received baseband signal by each diffusion code. The reverse-diffused signals of each path are arbitrated in phase then synthesized. Thus, received packet data in a prescribed transmission format is obtained. The received packet data is input to a compression/expansion processing unit (hereinafter, referred to as compander) 17.

The compander 17 separates the received packet data output from the CDMA signal processing unit 16 for each medium by a demultiplexing unit. The compander 17 performs decoding processing to the demultiplexed data for each medium, respectively. The compander 17, for instance, in a speech mode, decodes audio data such as a speech voice included in the received packet data by means of a speech codec.

The portable telephone set regarding the one embodiment of the present invention has a so-called television telephone function. Like a television telephone, if the received packet data includes video data, the compander 17 decodes the video data by a video codec.

A digital audio signal obtained through the decoding processing is supplied to a PCM code processing unit (hereinafter, referred to as PCM codec) 18. The PCM codec 18 PCM-decodes the digital audio signal output from the compander 17 to output an analog audio signal. The analog audio signal is amplified by a reception amplifier 19 then output from a loud-speaker 20.

When an audio reproduction mode is set, the control unit 23 reads out the corresponding audio content from a storage unit 24 then amplifies and outputs the audio content from the loud-speaker 20 through the PCM codec 18 and the reception amplifier 19 after the decoding processing of the audio content.

The digital video signal decoded by the compander 17 is input to the control unit 23. The control unit 23 displays the digital video signal output from the compander 17 onto a display 28 through a video RAM. The control unit 23 displays not only the received video data but also video data imaged by a below-mentioned camera 33 onto a display 28 through a video RAM.

If the received packet is e-mail, the compander 17 supplies the e-mail to the control unit 23. The control unit 23 stores the e-mail in the storage unit 24. The control unit 23 reads out the e-mail from the storage unit 24 in response to a display operation conducted through an input device 27 by a user to display it onto the display 28.

On the contrary, in a speech mode, a voice signal of a speaker input to a microphone 21 is amplifies up to an appropriate level by a transmission amplifier 22 then converted into the digital audio signal through the PCM coding processing by the PCM codec 18 to be input to the compander 17. The video signal output from the below-mentioned camera 33 is digitized by the control unit 23 to be input to the compander 17. The e-mail created by the control unit 23 is also input to the compander 17 from the control unit 23.

The compander 17 detects an energy quantity of the input voice from the digital audio signal output from the PCM codec 18 to decide a transmission data rate on the basis of the detection result. The compander 17 encodes the digital audio signal into a signal in a format corresponding to the transmission data rate. Thus, the compander 17 generates audio data. The compander 17 encodes the digital video signal output from the control unit 23 to generate video data. The compander 17 packetizes the audio data and video data by means of the demultiplexing unit in accordance with a prescribed transmission format to output this transmission packet data to the CDMA signal processing unit 16. Even when the e-mail is output from the control unit 23, the compander 17 multiplexes the e-mail onto the transmission packet data.

The CDMA signal processing unit 16 performs spectrum diffusion processing to the transmission packet data output from the compander 17 by using a diffusion code assigned to a transmission channel. The processing unit 16 outputs its output signal to a transmitting circuit (TX) 15. The TX 15 modulates the spectrum-diffused signal by using a digital modulation system such as a quadrature phase shift keying (QPSK) system. The TX 15 synthesizes the transmission signal generated through the modulation with the local oscillation signal generated from the SYN 14 to frequency-convert it into the radio signal. The TX 15 high-frequency-amplifies the radio signal so as to reach the transmission power level instructed from the control unit 23. The amplified radio signal is fed to the antenna 11 through the DUP 12 to be transmitted toward the base station, not shown.

A power supply circuit 26 generates a prescribed operation power voltage Vcc from an output of a battery 25 to supply it to each circuit. The battery 25 is charged by a charging circuit 29.

Meanwhile, the control unit 23 has, for instance, a microcomputer, that is a central processing unit (CPU). Operation control characterizing the portable telephone set regarding the one embodiment of the present invention and being conducted by the control unit 23 mainly includes the following operation control.

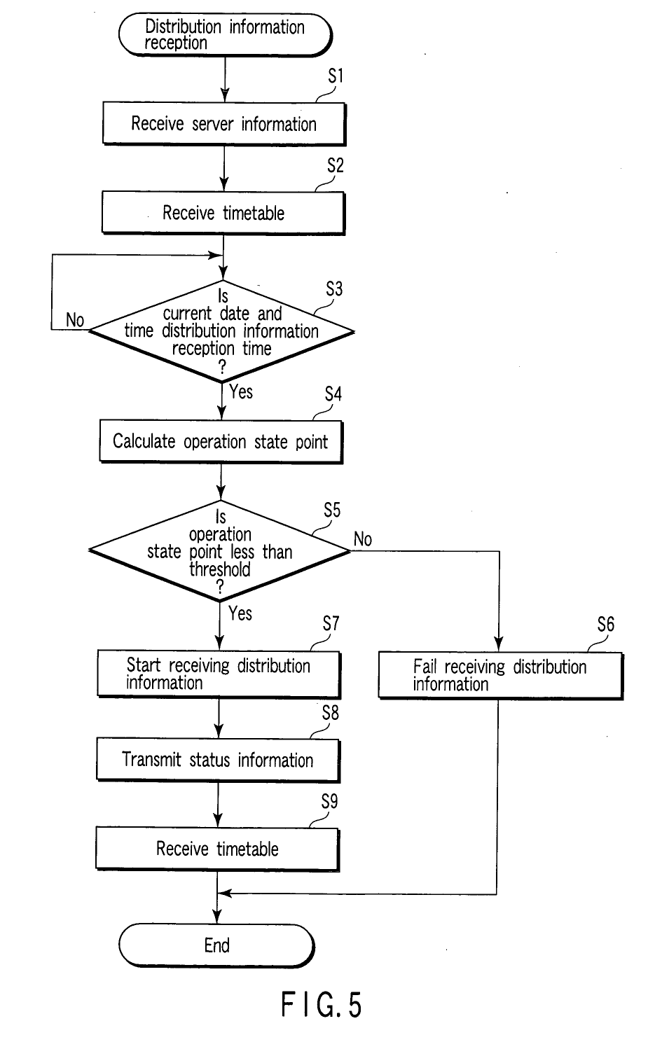

That is to say, when performing the reception processing of the distribution data in the information distribution service, etc., the control unit 23 firstly determines whether the portable telephone set is in the operation state or not. In the determination, the control unit 23 does not determine whether or not the portable telephone unit is in only a stand-by screen display conventionally, but comprehensively determines by adding various conditions described below. The detail of the determination will be described later by referring to FIG. 5-FIG. 7.

Here, the portable telephone set regarding the one embodiment of the present invention is provided with a position detection unit 41 by a global positioning system (GPS) as a member to detect position information to be used for determination of presence or absence, of a position movement of the portable telephone set, that is one of the various conditions.

Similarly, as the member to detect the movement information to be used for the determination of the presence or absence, of the position movement of the portable telephone set, that is one of the various conditions, an acceleration sensor 43 that is a sensor outputting a magnitude of an acceleration added to the portable telephone set is disposed. The acceleration sensor 43 can detect an inclination of the portable telephone set. Therefore, based upon the inclination detected by the acceleration sensor 43, the portable telephone set can correct the display screen on the display 28 on the basis of the inclination detected by the acceleration sensor 43. The acceleration sensor 43 can also detect a swinging extent when the user moves. Accordingly, the acceleration sensor 43 can be used as a pedometer.

By the way, the camera 33 is one to conduct imaging. For the portable telephone set regarding the one embodiment of the present invention, the video data as a display video in the television telephone is imaged and obtained by means of the camera 33.

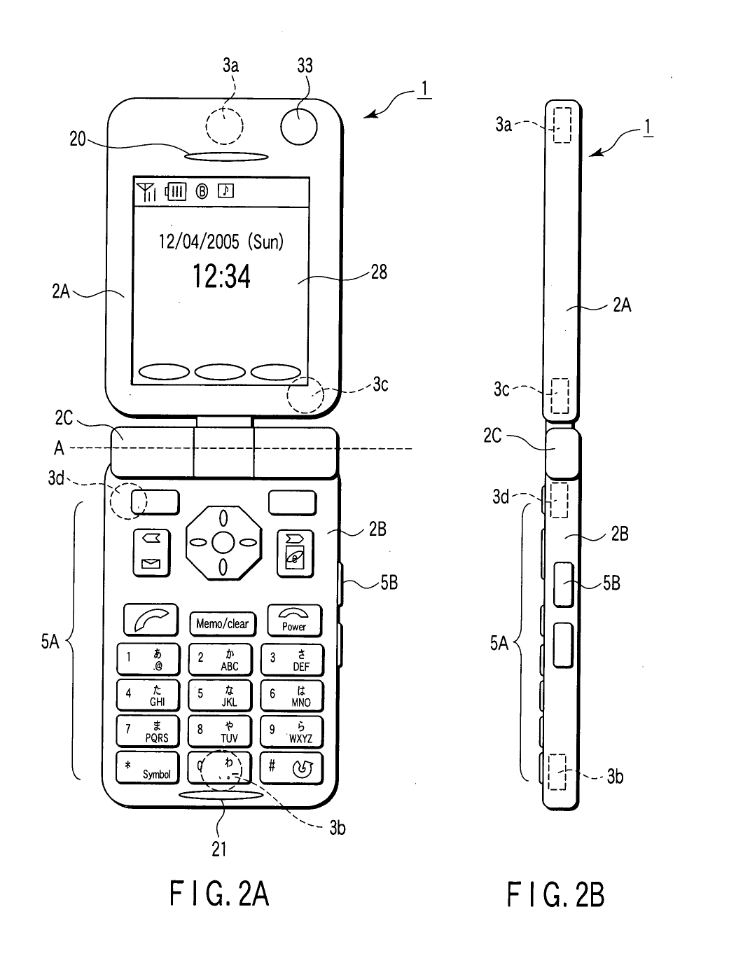

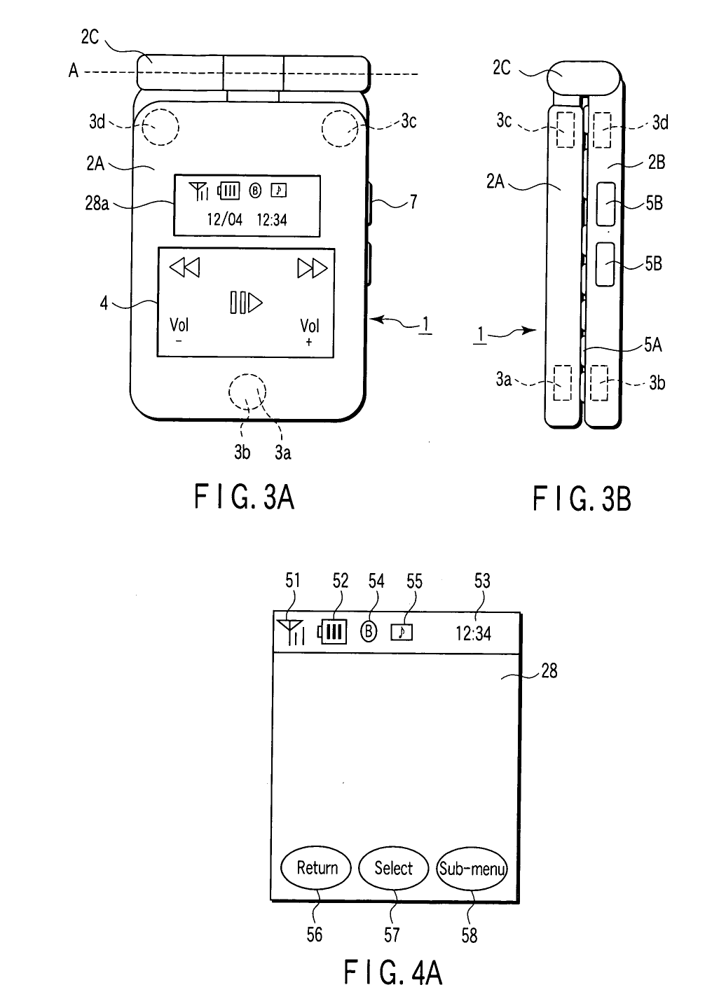

Hereinafter, one example of the outer appearance of the portable telephone set regarding the one embodiment of the present invention will be set forth with reference to FIG. 2A, FIG. 2B, FIG. 3A and FIG. 3B.

Here, FIG. 2A is a front view when a portable telephone set 1 is opened by around 180°. FIG. 2B is a side view when the portable telephone set 1 is opened by around 180°. FIG. 3A is a front view when the portable telephone set 1 is closed. FIG. 3B is a side view when the portable telephone set 1 is closed. Here, in the portable telephone set 1, an upper case 2A and a lower case 2B are connected with each other through a hinge part 2C. Namely, the hinge part 2C enables switching over between a shell open state and a sell closed state (switch over of shell open/closed state).

The upper case 2A has the display 28 composed of the LCD, etc., the loud-speaker 20 as a receiver to output the received voice, magnetic sensors 3a and 3c to detect the state of the portable telephone set 1, a sub-display 28a composed of the LCD, etc., and an electrostatic touch pad 4.

Here, the sub-display 28a and the electrostatic touch pad 4 are disposed on the same surface of the upper case 2A. Similarly, the loud-speaker 20, the display 28 and the camera 33 are disposed on the same surface of the upper case 2A.

The lower case 2B includes keys 5A and side keys 5B to input operations, etc., of numeric figures, characters and the portable telephone set 1, a microphone (in FIG. 2A, indicating a transmission mouth) 21 to collect sounds, and magnetic sensors 3b and 3d to detect the state of the portable telephone set 1. The keys 5A and side keys 5B shown in FIG. 2A and FIG. 2B are correspond to the input device 27 shown in FIG. 1.

The magnetic sensors 3a-3d disposed at the upper and the lower cases 2A and 2B output detection signals when the mutual sensors 3a-3d are brought into a state in which they become close to within predetermined distances. Here, a pair consisting of the magnetic sensors 3a and 3b among each sensor 3a-3d is one to detect whether or not the upper case 2A and the lower case 2B overlap with each other.

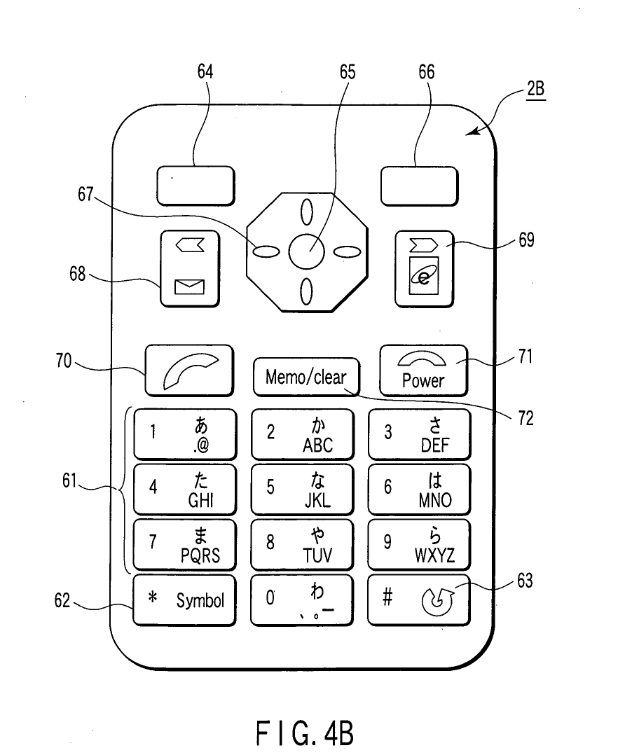

Hereinafter, a display example of the display 28 and an arrangement example of the key 5A will be set forth. Here, FIG. 4A is a view showing a display example of the display 28. FIG. 4B is a view showing an arrangement example of the key 5A.

As shown in FIG. 4A, on the display 28, on the uppermost line (hereinafter, referred to as upper PICT (picture)) line); an antenna PICT 51 indicating a level of sensitivity of the present antenna 11, a battery PICT 52 indicating the present battery remaining quantity of the telephone set, a time display 53 indicating the present time, a Bluetooth (BT, registered trade mark) icon 54 displayed during initiation of the BT, and a music icon 55 displayed, for instance, during initiation of a music player (hereinafter, referred to as MP); are displayed.

During the connection of the BT, in the BT icon 54, the background of which, is displayed in blue (inside ellipse of FIG. 4 is colored in blue). In a server operation (BT connection waiting state), the BT icon 54 is indicated in white (inside ellipse of FIG. 4 is colored in white). When the BT connection is not performed (including the case of shutdown of BT link), the BT icon 54 is controlled so as to be turned off.

When the MP is activated as described above, the music icon 55 is displayed. The music icon 55 is also displayed in the time when the MP is reproduced as background (hereinafter, referred to as BGM). In the case of other than this, the music icon 55 is turned off through the control by the control unit 23.

Meanwhile, on the lowermost line (hereinafter, referred to as lower PICT line) on the display 28, at the relevant time point, a simple description of functions executed in the case of pressing operations of a soft-key left 64, a decision key 65 (central part of cross key 67), and a soft-key right 66 are indicated as a left lower PICT 56, a middle lower PICT 57, and a right lower PICT 58.

Here, the left lower PICT 56, the middle lower PICT 57, and the right lower PICT 58 are responded to the soft-key left 64, the decision key 65, the soft-key right 66, respectively.

For instance, if the display shown in FIG. 4A is performed on the display 28, the pressing operation of the soft-key left 64 executes a function of “return”. The pressing operation of the decision key 65 selects a function being in focus now, although it is not shown in FIG. 4A. Pressing and operating the soft-key right 66, “sub-menu” is displayed on the display 28.

By the way, as shown in FIG. 4B, the lower housing part 2B has numeric character keys 61, a “” key 62, a “#” key 63, a soft-key left 64, a decision key 65, a soft-key right 66, a cross-key 67, a mail key 68, a browser key 69, a speech key 70, a power key 71, and a clear key 72.

Here, Japanese “KANA” characters, symbolic characters, alphabets, etc., other than the numeric characters are assigned to the numeric character keys 61. For example, to the key of “1”, a numeric character “1”, “KANA” characters of “a”, “i”, “u”, “e” and “o”, and symbols of “.” and “@” are assigned. A numeric character “2”, Japanese “KANA” characters of “ka”, “ki”, “ku”, “ke” and “ko”, and alphabets of “A”, “B”, “C”, “a”, “b”, “c”, etc., are assigned to, for instance, the key of “2”.

To the “” key 62, a symbol “” is assigned. The “” key 62 is also one to call a symbol list and an icon list in a character input status. A symbol “#” is assigned to the “#” key 63. In the character input status, the “#” key 63 is also one to inverse a toggle on a character input by the numeric character key 61.

The cross key 67 has an up key, a down key, a left key, a right key, and a decision key 65. Namely, the cross key 67 is a key to move a cursor, etc., toward up, down, right, and left directions. The decision key 65 is one to decide a various functions. The mail key 68 is one to call transmission and reception functions. The browser key 69 is one to connect to Web, etc.

The speech key 70 is one to be used mainly for receiving a telephone call and normally making a transmission. The power key 71 is one mainly to turn on/off a power source, operate for terminating speech, and conduct termination operations of functions, editing, etc. Further, the clear key 72 is one mainly to clear the functions, editing, etc., and delete characters in inputting the characters. While the display 28 displays a standby screen, if the clear key 72 is pressing-operated, a memo pad is called out to be displayed on the display 28.

Hereinafter, a series of operation control of the reception processes of the distribution data in the information distribution service (unicast distribution) by the control unit 23 of the portable telephone set regarding the one embodiment of the present invention will be set forth with reference to a flowchart shown in FIG. 5.

At first, the control unit 23 receives server information that is information relating to a server of an information distribution server to be utilized (step S1). Next to this, the control unit 23 receives time table information in the information distribution service (step S2).

Here, the time table information includes date and time to receive the distribution data from the information distribution service (date and time to access to the server and download the distribution data), date and time to transmit (up-load) status information showing the status of the portable telephone set, such as a completion of the reception processing of the distribution data from the information distribution service, and date and time to update the time table information at the next time or later.

In regard to the step S1 and the step S2, they are steps to be required at the first time of making use of the information distribution service, so that they are not necessary for receiving at the second time or later.

After completing the processing in the step S2, the control unit 23 determines whether or not the current date and time is the data and time of receiving the distribution data in the time table information (step S3). In the case of branching the step S3 to “NO”, the control unit 23 returns to the step S3 again. The step S3, namely, is a step to wait until it becomes the reception processing time of the distribution data in the time table information.

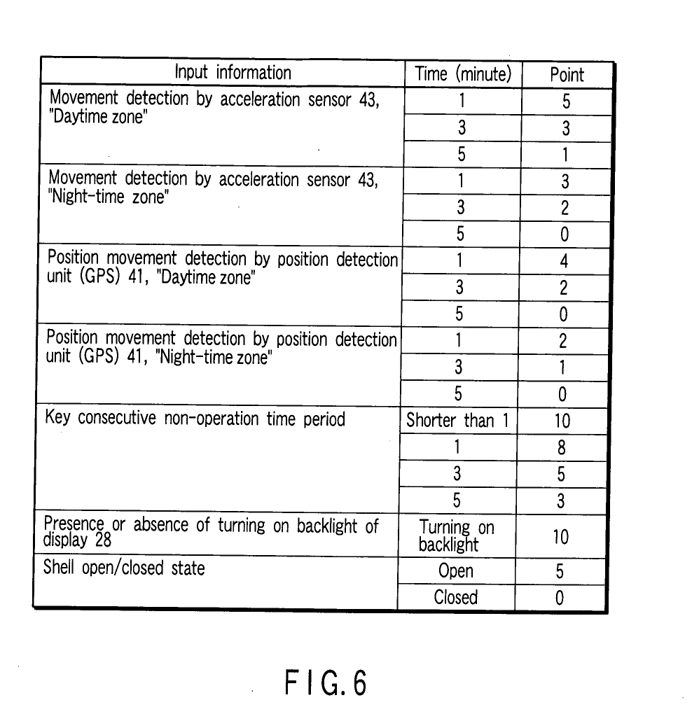

In the case of branching the step S3 to “YES”, the control unit 23 calculates operation state points to be references for determining whether or not the portable telephone set is in an operation state (step S4). Hereinafter, a concrete calculation method of the operation state points will be described by referring to FIG. 6 illustrating one example of a point calculation table.

In the one example of the present invention, the control unit 23, as shown in FIG. 6, obtains and adds the respective operation state points, on the basis of the movement information detected by the acceleration sensor 43, the position movement information detected by the position detection unit 41, non-operation hours of each key (the numeric figure keys 61, “*” key 62, “#” key 63, software left key 64, decision key 65, software key right 66, cross-shape key 67, mail key 68, browser key 69, speech key 70, power key 71, clear key 72 and side key 5B), the presence/absence of turning on of the backlight at the display 28, and the shell open/closed state. More specifically, they are given as follows:

(1) Point Addition on the Basis of the Movement Information Detected by the Acceleration Sensor 43

The control unit 23 determines the presence or absence of the movement of the portable telephone set from the movement information detected by the acceleration sensor 43, and adds up 5-point if the non-movement time lasts one minute or longer and lasts shorter than three minutes, 3-point if it lasts three minutes or longer and lasts shorter than five minutes, and 1-point if it lasts five minutes or longer, respectively, as the operation state points.

These operation state points are those in the day-time zone, in the night-time zone, these operation state points are established as follows. Namely, the control unit 23 adds up 3-point if the time period of the non-movement lasts one minute or longer and lasts shorter than three minutes, 2-point if it lasts three minutes or longer and lasts shorter than five minutes, and 0-point if it lasts five minutes or longer, respectively, as the operation state points.

That is, the portable telephone set establishes the operation state points, in a day-time zone in which there is every possibility that the portable telephone set is in an operation state, at higher than that there is little possibility that the portable telephone set is in the operation state such as in a night-time zone. Like this, by weighting the additional points on the basis of a living pattern of the user of the portable telephone set, the portable telephone set can further accurately determine whether it is in the operation state or not.

(2) Point Addition on the Basis of the Position Movement Information Detected by the Position Detection Unit 41

The control unit 23 determines the presence or absence of the movement of the portable telephone set on the basis of the position movement information detected by the position detection unit 41, and adds up 4-point if the non-movement time lasts one minute or longer and lasts shorter than three minutes, 2-point if it lasts three minutes or longer and lasts shorter than five minutes, and 0-point if it lasts five minutes or longer, respectively, as the operation state points.

The additional points are those in the day-time zone, and in the night-time zone, they are established as follows. That is, the control unit 23 adds up 2-point if the non-movement time lasts one minute or longer and lasts shorter than three minutes, 1-point if it lasts three minutes or longer and lasts shorter than five minutes, and 0-point if it lasts five minutes or longer, respectively, as the operation state points. Like this, the reason why the additional points are weighted depending on the day-time zone and on the night-time zone is given above.

The reason why the operation state points based on the position movement information detected by the position detection unit 41 are established at the points lower than the operation state points based on the movement information detected by the acceleration sensor 43 is the detection of the position information by means of a GPS is usually not so excellent in precision.

(3) Point Addition on the Basis of Non-Operation Times of Each Key

The control unit 23 detects the non-operation times of each key, and adds up 10-point if the non-operation times last shorter than one minute, 8-point if they last one minute or longer and last shorter than three minutes, 5-point if they last three minutes or longer and last shorter than five minutes, and 3-point if they last five minutes or longer, respectively, as the operation state points.

Since the presence or absence of the key operations is information which can clearly determine whether the portable telephone set is in the operation state or not, the operation state points are set at relatively higher points than other conditions.

(4) Point Addition on the Basis of Presence or Absence of Turning on the Backlight at the Display 28

The control unit 23 detects the presence or absence of the turning on of the backlight at the display 28, and adds up 10-point if the backlight is turned on, as the operation state point. If the backlight is not turned on, since the portable telephone set is possibly not in the operation state, the points are nod added.

(5) Point Addition on the Basis of the Shell Open/Closed State

When being in the shell open state (state shown in FIG. 2), the control unit 23 adds up 5-point as the operation state point, and when being in the shell closed state (state shown in FIG. 3), it does not adds any point. Since a lot of users who leave cellular telephone sets in the shell open states as they are, the operation state points there are not set to so higher points.

The control unit 23, as mentioned above, successively adds up the operation state points to obtain a total value thereof. The specific values of the operation state points in the point calculation table shown in FIG. 6 are just examples, and the values of the operation state points are not limited to the specific values undoubtedly.

For example, it is also acceptable for the cellular telephone that the control unit 23 does not obtain points with specific values, does not perform the processing in the step S4 and the determination (determination whether or not being in operation state) in the step S5, but determines whether or not the cellular telephone is in the operation state by using the following determination method to transit to the below-described step S6 or step S7 in accordance with the determination result.

More specifically, the control unit 23 determines whether or not the cellular telephone is in the operation state depending on whether it satisfies the following conditions (1)-(5). That is, in accordance with the following conditions (1)-(5), the control unit 23 performs the following steps (A)-(C):

(1) In the case in which the cellular telephone does not perform any one or all of, a telephone call, a packet communication (transmission or reception) and a short-distance radio communication with outside

(2) In the case in which a key consecutive non-operation time has exceeded a prescribed time period

(3) In the case in which the display 28 is controlled to a state where it does not make a display, or a prescribed time has elapsed after controlling it in the state where it does not make the display

(4) In the case in which the shell is closed, or a prescribed time has elapsed after closing it

(5) In the case in which the backlight of the display 28 is not turned on, or a prescribed time has elapsed after beginning the state where the backlight of the display 28 is not turned on.

(A) If one or more conditions are satisfied, the control unit 23 shifts to the step S7, and in other cases, it shifts to the step S6

(B) If two or more conditions are satisfied, the control unit 23 shifts to the step S7, and in other cases, it shifts to the step S6

(C) If the condition (1) is satisfied and more than one conditions out of the conditions (2)-(5) are satisfied, the control unit 23 shifts to the step S7, and in other cases, it shifts to the step S6.

Hereinafter, we will return to the description of the flowchart shown in FIG. 5.

After calculating the operation state points on the basis of the various conditions given in the step S4, the control unit 23 determines whether or not the operation state points are not more than predetermined thresholds (step S5). For branching the step S5 to “NO” (if the operation state points exceed prescribed threshold), the control unit 23 determines that the cellular telephone is in the operation state and does not conduct the reception processing of the distribution data in the information distribution service (step S6). Namely, the reception processing of the distribution data results in failing and the control unit 23 terminates the reception processing process of the distribution data.

The time table information usually having included the date and time information for each week, as long as the cellular telephone fails to receive the distribution data for consecutive one week, the time table information relating to the distribution data of the next time has been secured.

On the contrary, if the step S5 is branched to “YES”, the control unit 23 starts the reception processing of the distribution data in the information distribution service (step S7). That is, the step S7 is a step to download the distribution data from the server.

After completing the reception processing which has started in the step S7, the control unit 23 transmits (uploads) the status information of the cellular telephone set, showing the fact of the completion of the reception processing, to the server (step S8). The control unit 23 then controls to receive new time table information from the server (step S9) to terminate the process of the reception processing of the distribution data. The dates and times to conduct the processing in the steps S8 and S9 follow with the time table information.

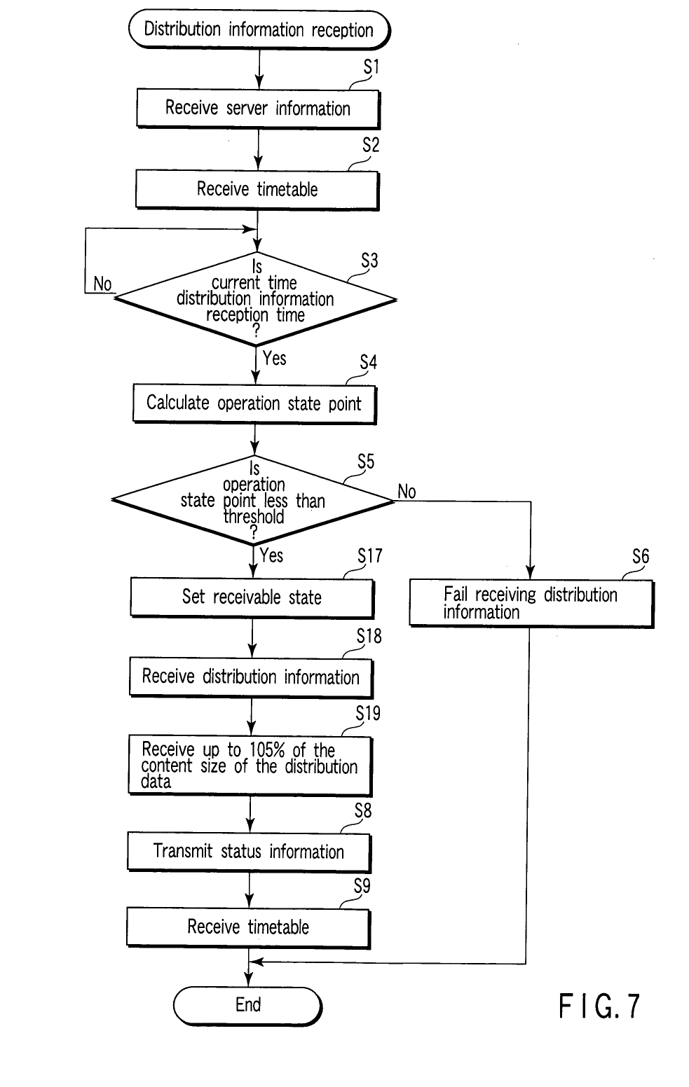

Hereinafter, a series of operation control of the reception processing process of the distribution data in the information distribution service (multicast distribution) by means of the control unit 23 of the cellular telephone regarding the one embodiment of the present invention will be described by referring to a flowchart shown in FIG. 7. Steps performing the same operation control as those of the flowchart shown in FIG. 5 are designated by the identical step numbers and their descriptions are eliminated.

When the step S5 is branched to “YES”, the control unit 23 establishes the cellular telephone in a state where it can conduct the reception processing of the distribution data in the information distribution service (step S17) to conduct the reception processing of the distribution data transmitted from the server (step S18). After this, if the control unit 23 determines that the cellular telephone has already received, for instance, 105% of the content size of the distribution data (data with the same or larger content size is acceptable) (step S19), it converts the distribution data into reproducible data and shifts to the step S8.

The step S19, is a step so as to prepare information with a size larger than that of the content data in advance in expectation of a reception error, and receives the content data. Then, when the reception error occurs later, the step S19 can recover the error from the data which has been received successfully.

In the information distribution service through the multicast distribution, such a service to distribute data of news content, etc., for each prescribed time interval (for example, for every 30 minute) having been available, in such case, it is of course acceptable to shift to the step S8 after repeating the steps S3-S19 by a plurality of times by entering the loop thereof.

As mentioned above, according to the one embodiment of the present invention, a portable terminal device having a high reception completion rare of data in utilizing the information distribution service, etc.

More particularly, in the one embodiment of the present invention, as described with reference to FIG. 6, the portable terminal device obtains operation state points by expressing a various conditions numerically to add them, and comprehensively determines whether or not the portable terminal device is in the operation state on the basis of the operation state points. Thereby, it is possible to prevent the portable terminal device from being determined that it is in the operation state, and from failing the reception processing of the distribution data of the information distribution service, etc., due to the determination that the portable terminal device is in the operation state because the display is not in the so-called stand-by screen display state, though the portable terminal device is not actually in the operation state as compared with a conventional portable terminal device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A portable terminal device capable of receiving distribution data from a server, comprising:
a detection unit configured to detect an operation state of the portable terminal device;
a determining unit configured to determine between a first state and a second state, the first state being that the portable terminal device is in the operation state on the basis of the state detection result by the detection unit; and
a reception control unit configured to perform reception processing of the distribution data from the server if the determining unit determines that the portable terminal device is in the second state.

2. The portable terminal device according to claim 1, wherein
the portable terminal device is a folding-type portable terminal device, and
the detection unit is at least any one of a position detection unit configured to detect a position of the portable terminal device, an acceleration sensor configured to detect a movement of the portable terminal device, a key operation detection unit configured to detect presence or absence of a key operation at the portable terminal device, a lighting detection unit configured to detect presence or absence of lighting of a backlight at a display of the portable terminal device, and a folding detection unit configured to detect whether or not the portable terminal device is in a state of being folded.

3. The portable terminal device according to claim 2, wherein
the determining unit calculates state points that are indexes to determine whether or not the portable terminal device is in an operation state on the basis of the detection result from the detection unit, and when the state points exceed a prescribed threshold, it determines that the portable terminal device is in the first state.

4. The portable terminal device according to claim 3, wherein the state determining unit
calculates a time in which a position of the portable terminal device has not varied on the basis of the detection result from the position detection unit, and adds up larger values as the state points as the calculated time is shorter;
calculates a time in which the portable terminal device has not moved on the basis of the detection result from the acceleration sensor, and adds up larger values as the state points as the calculated time is shorter;
calculates a time in which the portable terminal device has not been continuously performed by any key operations on the basis of the detection result from the key operation detection unit, and adds up the larger values as the state points as the calculated time is shorter;
adds up prescribed state points if it determines that a backlight at a display of the portable terminal device is turned on the basis of the detection result from the lighting detection unit;
adds up prescribed state points if it determines that the portable terminal device is not in a state of being folded on the basis of the detection result from the folding detection unit; and
determines that the portable terminal device is in the first state if a total value of the calculated state points exceeds a prescribed threshold.

5. A portable terminal device capable of receiving distribution data from a server, comprising:
an operation detection unit configured to detect an operation state of the portable terminal device;
a point calculation unit configured to calculate operation state points to determine whether or not the portable terminal device is in the operation state on the basis of the detection result from the operation detection unit; and
a reception control unit configured to determines whether or not the operation state points exceed a prescribed threshold, and if it is determined that they do not exceed the prescribed threshold, it conducts reception processing of the distribution data from the server.

6. A portable terminal device capable of receiving distribution data from a server, comprising:
a state detection unit configured to detect an operation state of the portable terminal device; and
a reception control unit configured to determine whether or not the portable terminal device is in the operation state on the basis of the state detecting result from the state detection unit, and if it is determined that the portable terminal device is not in the operation state, it performs reception processing of the distribution data from the server.

7. The portable terminal device according to claim 6, wherein the reception control unit determines that the portable terminal device is in the operation state to perform reception processing of the distribution data from the server if the portable terminal device satisfies one or more conditions (1)(5) described as follows:
(1) In the case in which the portable terminal device is not in a telephone call or in a data communication
(2) In the case in which a time period of non-operation of an operation unit has exceeded a prescribed time period
(3) In the case in which the portable terminal device controls to a state where a display unit does not make a display, or a prescribed time period has elapsed after the display unit is controlled so as not make the display
(4) In the case in which the portable terminal device has been closed, or a prescribed time period has elapsed after the portable terminal device is closed
(5) In the case in which a backlight of the display unit has not turned on, or a prescribed time period has elapsed after the backlight has been turned off.

8. The portable terminal device according to claim 6, wherein the reception control unit determines that the portable terminal device is in the operation state to perform reception processing of the distribution data from the server if the portable terminal device satisfies a plurality of conditions (1)-(5) described as follows:
(1) In the case in which the portable terminal device is not in a telephone call or in a data communication
(2) In the case in which a time period of non-operation of an operation unit has exceeded a prescribed time period
(3) In the case in which the portable terminal device controls to a state where a display unit does not make a display, or a prescribed time period has elapsed after the display unit is controlled so as not make the display
(4) In the case in which the portable terminal device has been closed, or a prescribed time period has elapsed after the portable terminal device is closed
(5) In the case in which a backlight of the display unit has not turned on, or a prescribed time period has elapsed after the backlight has been turned off.

9. The portable terminal device according to claim 6, wherein the reception control unit determines that the portable terminal device is in the operation state to perform reception processing of the distribution data from the server if the portable terminal device is not in a telephone call or in a data communication, and also satisfies at least one or more conditions (1)-(4) described as follows:
(1) In the case in which a time period of non-operation of an operation unit has exceeded a prescribed time period
(2) In the case in which the portable terminal device controls to a state where a display unit does not make a display, or a prescribed time period has elapsed after the display unit has been controlled so as not to make the display
(3) In the case in which the portable terminal device has been closed, or a prescribed time period has elapsed after the portable terminal device is closed
(4) In the case in which a backlight of the display unit has not turned on, or a prescribed time period has elapsed after the backlight is turned off.
